(19) United States
(12) Patent Application Publication
(10) Pub. No.: US 2005/0236844 A1
(43) Pub. Date: Oct. 27, 2005

(54) Device for operating by motor a section door, a swinging door and the like

(76) Inventor: Ivo Finardi, Arese (IT)

Correspondence Address: YOUNG & THOMPSON, 745 SOUTH 23RD STREET, 2ND FLOOR, ARLINGTON, VA, 22202, US

(21) Appl. No.: 11/114,008

(22) Filed: Apr. 26, 2005

(30) Foreign Application Priority Data
Apr. 26, 2004 (IT) TO2004A000256

(51) Int. Cl. E05C 1/06

(52) U.S. Cl. 292/38

(57) ABSTRACT

A device intended to be applied to section doors, swinging doors and other similar kinds of doors, in order to allow a correct maneuver of the blocking elements when the door is operated by a motor, which includes: a bracket intended for application to the upper edge of a door; a swinging member acting as a square lever, pivoted on the bracket, having a first articulation element for a shaft connected to a motor, and having a second articulation element for a tie-rod connected to the mechanisms for releasing the blocking elements of the door; and a member for limiting the swing field allowed to the swinging member. Preferably, the device includes a strong spring acting between the bracket and the swinging member in the same sense as the traction exerted on the swinging member by the shaft connected to the motor during the operation of opening the door.

### BACKGROUND OF THE INVENTION

The subject of the present invention is a device intended to be applied to section doors, swinging doors and other similar kinds of doors, in order to allow a correct maneuver of the blocking means when the door is operated by a motor.

When a door having blocking means, such as bolts operated by a release device and possibly by a lock, is provided with an actuating motor, it is needed that some means are provided for releasing the door blocking means when the motor starts operating the door opening, and before the opening displacement is effectively transmitted by the motor to the door. In effect, if an opening force is applied to the door before release of the blocking means, strong frictions take place, that could then hinder the release of the blocking means. In order to prevent such a trouble, use is made of a device which inserts in the means transmitting the movement from the motor to the door a dead stroke. During this dead stroke a traction is exerted onto a flexible tie-rod acting on an appropriate device, and possibly through the lock, in order to release the door blocking means.

The known devices intended for this operation have some disadvantages. The device that introduces in the transmission means a dead stroke requires the movable connection of component parts which displace under strong load with sliding friction, and therefore they cause severe resistances. The tie-rod is formed by a flexible cable which is deviated under a small radius bending, and it suffers a premature deterioration. In order to ensure that the blocking means are released before a traction is applied to the door, the regulation of the balancing means of the door should be made by deficiency. As a consequence, the manual operation of the door in case of lack of electric current or damage to the motor becomes excessively fatiguing. A device for motor operation cannot be easily added to an existing door, because it requires that the balancing of the door be modified, and this operation is difficult. The known devices, when they are used in the presence of blocking means, such as side bolts, that are intended for automatical spring in the blocking position when the door is closed, introduce a continuous sliding of the bolts under elastic bias against the corresponding guide during the entire stroke of closing the door, thus causing friction and wear.

### SUMMARY OF THE INVENTION

In view of this situation, the main object of the invention is to provide a device intended to be applied to section doors, swinging doors and other similar kinds of doors, in order to allow a correct maneuver of the blocking means when the door is operated by a motor, which should be free from the disadvantages of the known devices, or have such disadvantages at a reduced extent.

Another object of the invention is to provide such a device that does not introduce noticeable resistances in the movement transmission from the motor to the door.

Still another object of the invention is to provide such a device that does not require any deviation under a small radius of the tie-rod connected to the door blocking means, so as to ensure a long duration of this tie-rod.

It is still another object of the invention, in a further development thereof, to provide such a device capable of ensuring that the motor traction is applied to the door only after the blocking means have been released, and this without requiring a deficient balancing of the door.

As a consequence, it is also an object of the invention to provide such a device that allows easy application of motor means to an existing door, without requiring any modification of the door balancing.

Finally, it is an object of the invention to provide such a device that, when there are present side bolts sliding in a guide and intended for automatical spring in the blocking position when the door is closed, allows preventing the bolts to slide against the guide under elastic bias as long as they still are far away from the blocking position.

According to the present invention, the main object is attained by means of a device comprising: a bracket intended for application to the upper edge of a door; a swinging member acting as a square lever, pivoted on said bracket along an axis parallel to said door edge, having a first articulation means for a shaft connected to a motor, and having a second articulation means for a tie-rod connected to the mechanisms for releasing the blocking means of the door; and a means for limiting the swing field allowed to the swinging member with respect to the bracket.

Thanks to these arrangements, the transmission of the movement from the shaft connected to the motor to the tie-rod for release of the door blocking means takes place through the swing of said swinging member. The rotation of the swinging member only involves the rotation friction of a pivot and not a sliding friction, and therefore does not introduce severe resistances. On the other hand, the means for limitation of the swing field, connected to the swinging member, are in no way subject to the operating force and do not introduce any resistance. The member acting as a square lever can be so shaped as to apply the traction to the tie-rod along the own direction of the tie-rod, and therefore it does not require any deviation of the tie-rod and does not subject the tie-rod to any stress capable of damaging the same. The opening traction exerted by the motor is applied to the door, through the bracket, only when the swing of the member acting as a square lever, during which the release of the blocking means takes place, has attained its limit.

Preferably, the angle under which said two articulation means of the swinging member are seen from the axis pivoting the swinging member with respect to the bracket is near a right angle. In this way, the tie-rod is biased along a direction at least approximately perpendicular to the direction of the traction exerted by the motor, and this corresponds to the usual arrangement of the installation, which involves an almost horizontal traction exerted by the motor and a direction almost vertical (when the door is closed) of the tie-rod intended for the release of the blocking means.

Preferably, said first articulation means of the swinging member is so arranged that, in the operating configuration taken by the device under the traction exerted by the motor, it is situated at a distance from the door plane larger than the distance from said plane of the axis pivoting the swinging member. As it will result clearly later on, this allows keeping the bolts always in a retracted position when they still are far away from the blocking position.

Advantageously, according to a further development of the invention, the device comprises a strong spring acting between said bracket and said swinging member in the same sense as the traction exerted on the swinging member by the shaft connected to the motor, during the operation of opening the door. Thanks to this arrangement, the force of the spring is added to the traction of the motor during the operation of releasing the door blocking means, before the application to the door of the opening traction. The bias exerted by the spring may be sized at a value per se sufficient to release the blocking means, and in this case no opening bias is applied by the motor to the door before the release of the blocking means. But, even if the bias exerted by the spring is sized at a value lower than that needed for releasing the blocking means, it is possible to ensure that the traction applied to the door during the release of the blocking means is insufficient for displacing the door, irrespective of its balancing. Therefore, the application of the device and the motor to an existing door does not require any modification of the door balancing, and thus it is rendered easy at a large extent.

### BRIEF DESCRIPTION OF THE DRAWINGS

These and other features, objects and advantages of the present invention will appear more clearly from the following description of an embodiment concerning a section door, which represents the main application of the device; but it will appear clear to those skilled in the art how the device according to the invention can find application to other kinds of doors which are movable under control of a motor. Therefore, the described embodiment is to be taken as a non limiting example. The following description is given with reference to the appended drawings, wherein:

FIG. 1 shows a diagrammatic representation of the installation of a section door, provided with side bolts controlled by a lock, and provided with an operating motor.

FIGS. 2 and 3 show in perspective the device according to the invention, in two characteristic functional configurations thereof.

FIG. 4 shows a side view of-the device, in the functional configuration corresponding to that of FIG. 2.

FIG. 5 shows a plan view of the device, in the functional configuration corresponding to that of FIG. 3.

FIG. 6 shows a cross section of the device, taken along line VI-VI of FIG. 5.

FIG. 7 shows a side view of the device, in another characteristic functional configuration.

### DETAILED DESCRIPTION OF THE PREFERRED EMBODIMENT

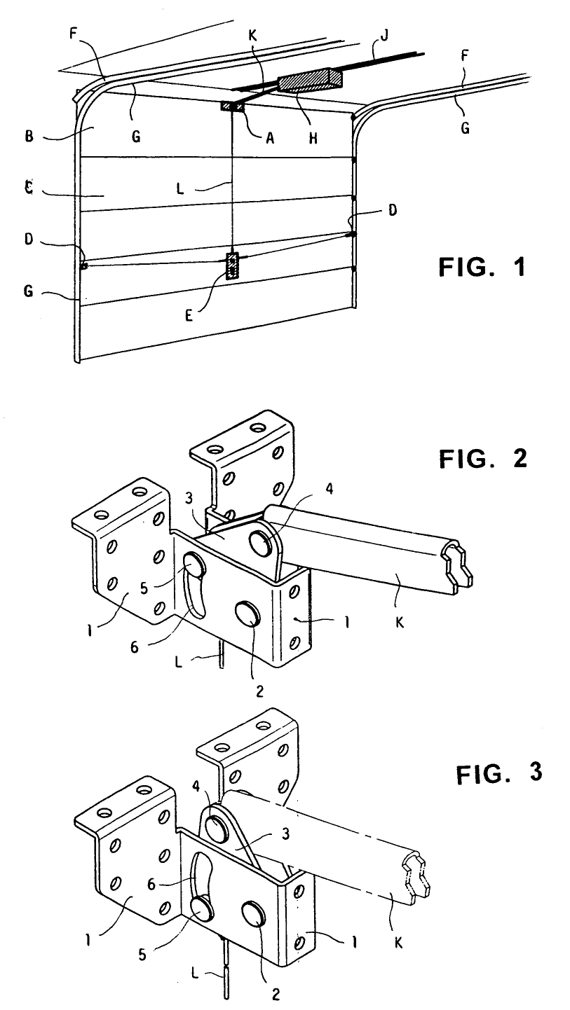

With reference to FIG. 1, letter A designates a device according to the invention, which is applied to the upper section B of a section door C represented in its closed position. Door C is blocked in its closed position by two side bolts D operated, in this case, by a central lock E, or even by any device capable of operating the release of the bolts D. The upper section B of door C is guided in its opening movement by rails F, whereas the other sections of door C are guided in their opening movement by rails G. The opening and closure of the door can be operated by a motor H, which displaces along a rail J. Motor H operates the door through a shaft K, and it operates the release of bolts D through a tie-rod L. Both the shaft K and the tie-rod L are connected to the device A. Apart from the device A according to the invention, the shown configuration of the installation is the conventional one of a section door.

With reference to FIGS. 2 to 7, which represent the device according to the invention, number 1 designates a bracket which is intended to be fixed to the upper edge of door C, and more in detail to the top edge of its upper section B. The surface of the upper section B facing the bracket 1 lies in a plane P. Bracket 1 carries a transversal axis 2, which is oriented in the same direction as the upper edge of section B to which the device is intended to be applied. On axis 2 is pivoted a swinging member 3 which, in the shown embodiment, has a triangular shape and has the function of a square lever. The swinging member 3 has a first articulation 4, to which is intended to be connected the shaft K of motor H, and it has a second articulation 5, to which is intended to be connected the tie-rod L. The axis of the articulation 5, in the shown embodiment, passes through an arcuate window 6 of bracket 1, thus forming a means 5-6 for limiting the field of swing of the member 3 with respect to the bracket 1. However, of course, the limitation means could also be provided in embodiments different from that shown.

FIGS. 3 and 6 show the device in the configuration that it assumes when the door, to which it is applied, is closed and extends in a vertical plane. The imaginary lines 2-4 and 2-5, which join the pivoting axis 2 to the articulations 4 and 5 of the swinging member 3, form an angle. This is the angle under which the articulations 4 and 5 are seen from the pivoting axis 2. The shaft K of motor H extends in a direction little diverging from the horizontal one. The tie-rod L extends in a direction little diverging from the vertical one. Therefore, when, as in the embodiment shown, the angle under which the articulations 4 and 5 are seen from the pivoting axis 2 is near to a right angle of 90°, the swinging member 3 transmits to the tie-rod L the forces coming from the shaft K of motor H by biasing the tie-rod L along the own direction of the tie-rod L itself.

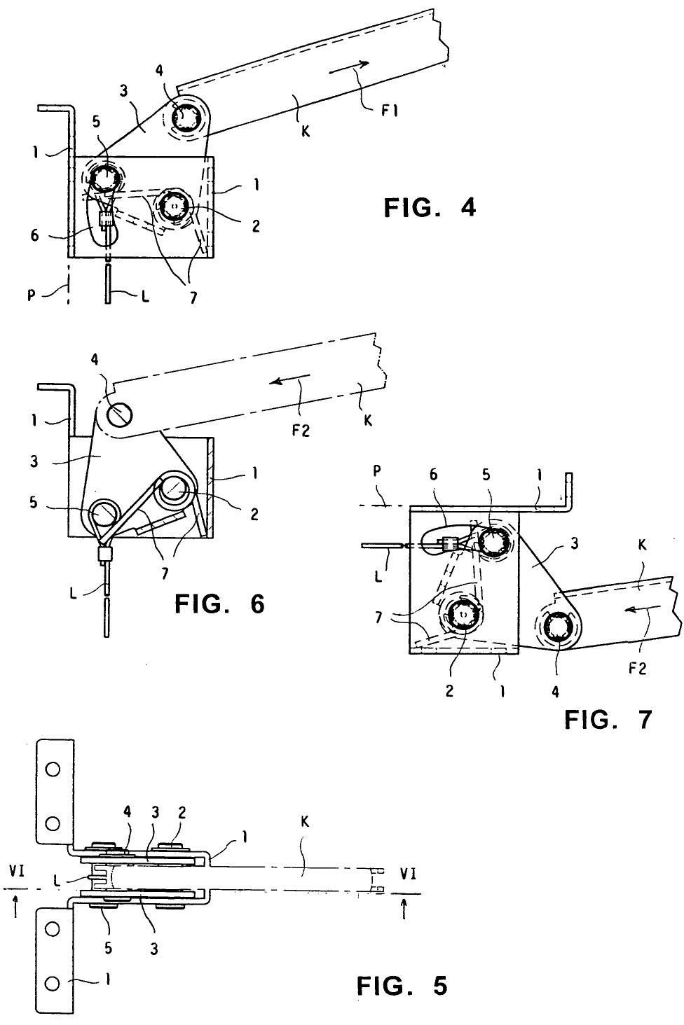

The first articulation 4 of the swinging member 3 is located in such a way that, in the operative configuration taken by the device under the traction exerted by the motor (namely, the configuration according to FIGS. 4 and 7), it lies at a distance, from the plane P of the door, larger than the distance from that plane P of the pivoting axis 2 of the swinging member 3.

In the preferred embodiment shown, on the pivoting axis 2 is wound a strong spring 7, that operates between the bracket 1 and the axis of the second articulation 5 of the swinging member 3 This spring biases the swinging member 3 towards the same limit position, allowed by the limitation means 5-6, towards which it is biased by the shaft K of motor H when this shaft transmits a traction according to arrow F1 of FIG. 4, in order to open the door. When, on the contrary, the shaft K of motor H transmits a force oriented according to arrow F2 of FIG. 6, in order to close the door, this force biases the swinging member 3 in a sense opposite to the former one, and it displaces the swinging member to the corresponding limit position allowed by the limiting means 5-6, against the action of spring 7.

The operation of the device according to the invention will now be described in its development, departing from the condition represented in FIG. 6 which, as it will appear later on, is the normal position when door C is closed, the bolts D are in blocking position and the irreversibility of motor H does not allow the spring 7 to spread out.

When motor H is operated in order to open the door, it exerts through the shaft K a traction in the sense opposite that of arrow F2. Therefore the spring 7 spreads out and causes the swinging member 3 to rotate in clockwise direction, according to the figures. On its turn the swinging member 3, through the articulation 5, exerts a traction onto the tie-rod L, and this latter, by acting on the lock E or other control means of the release of bolts D, causes the bolts D to retract and to release the blocking action exerted by them on the door. During this operation, the device passes from the configuration according to FIG. 6 to the configuration according to FIG. 4.

If the spring 7 is sized in order to supply a sufficient force, the action of releasing the blocking means D takes place by the sole action of spring 7. The movement of motor H has the only function of allowing the said action, which formerly was prevented by the irreversibility of the standing motor H. In this case, no bias in the sense of opening is applied to the door during the release of the blocking means.

If, on the contrary, the spring 7 is sized in order to supply a force which per se is not sufficient for releasing the blocking means, to the section B of door C is applied through the member 3, the axis 2 and the bracket 1 a residual force, corresponding to the difference between the force applied by motor H through the shaft K and the force exerted by the spring 7. More in detail, this difference is to be corrected by taking into account the ratio between the lengths of the two arms of the member 3 considered as a square lever. It is sufficient when this residual force is lesser than the force needed for lifting the door, taking into account the balancing thereof, in order that the release of the blocking means is ensured before transmission to the door of a force sufficient for starting its lifting. Therefore, it is possible to ensure the required conditions even with a relatively reduced sizing of the spring 7, with respect to the sizing needed for releasing the blocking means D by action of the spring 7 only.

When the action of releasing the blocking means is completed, and the device has attained the configuration according to FIG. 4, namely, the swinging member 3 has attained the corresponding limit position allowed to it, the force exerted by motor H through the shaft K is entirely applied, through the bracket 1, to the upper section B of the door C, and thus the door is lifted up to its complete opening. At the start of the opening displacement of the door C, the upper section B follows its rails F and rotates by 90°, namely, from a vertical plane to a horizontal plane, therefore also the bracket 1 rotates solidly with section B, and the device takes the configuration according to FIG. 7. This configuration is then maintained until the end of the opening movement of the door C.

When, during a subsequent operation of closure of the door, the motor H is operated in the sense opposite the former one, it exerts onto the shaft K a force oriented according to the arrow F2. The device has the configuration according to FIG. 7, and therefore the distance of the articulation 4 from the plane P is larger than the distance from plane P of the pivoting axis 2 of the swinging member 3. As a consequence, the line of action of the force applied by the shaft K to the swinging member 3 passes below the pivoting axis 2, and it does not allow the swinging member 3 to abandon the configuration according to FIG. 7. Therefore, the tie-rod L remains under traction condition and the bolts D are kept in retracted position. This fact rules out that in certain cases the bolts could slide against guide G by causing friction and wear.

When, finally, the lowering of door C is near to be completed, the upper section B of the door rotates from a horizontal position to a vertical position. The position of the device with respect to the shaft K of motor H passes from the position corresponding to the configuration according to FIG. 7 to the position corresponding to the configuration according to FIG. 4. As a consequence, the force applied by shaft K causes the swinging member 3 to rotate in counterclockwise direction, according to the Figures, and this member takes the position corresponding to the configuration according to FIG. 6. Therefore, the tie-rod L is no more biased, and the bolts D are free to automatically spring in the blocking position, if they are disposed for this operation. It is to be noted that this characteristic behavior of the device takes place both when the spring 7 is provided for, and when such a spring is not foreseen.

It is to be understood that this invention is not limited to the embodiment which has been described and shown as an example. Several possible modifications have been stated in the description, and others are available to those skilled in the art. These modifications, as well as any replacement by technically equivalent means, may be applied to what has been described and shown, without departing from the spirit of this invention and the scope of the present Patent as stated in the appended Claims.

1. A device intended to be applied to section doors, swinging doors and other similar kinds of doors,
said doors including a motor, a shaft connected to said motor, blocking means, a mechanism for releasing said blocking means and a tie-rod connected to said mechanism for releasing the blocking means,
wherein, in order to allow a correct maneuver of the door by said motor, the device includes:
a bracket intended for application to an upper edge of said door;
an axis mounted in said bracket parallel to said door edge;
a swinging member suitable for acting as a square lever, pivoted on said bracket along said axis for swinging within a fixed swing field;
said swinging member having a first articulation means for said shaft connected to said motor;
said swinging member having a second articulation means for said tie-rod connected to said mechanisms for releasing said blocking means of the door;
and a means for limiting the swing field allowed to said swinging member with respect to said bracket.

2. A device as set forth in claim 1, wherein said two articulation means of said swinging member are seen, from said axis pivoting the swinging member with respect to the bracket, under an angle near a right angle.

3. A device as set forth in claim 1, wherein said first articulation means of the swinging member is so arranged that, in the operating configuration taken by the device under the traction exerted by said motor, it is located at a distance from the door plane larger than the distance from said plane of said axis pivoting the swinging member.

4. A device as set forth in claim 1, wherein the device further comprises a strong spring acting between said bracket and said swinging member in the same sense as the traction exerted on said swinging member by said shaft connected to the motor during the operation of opening the door.

5. A device as set forth in claim 4, wherein the force exerted by said spring is sized at a value per se sufficient to release said blocking means.

6. A device as set forth in claim 1, wherein the force exerted by said spring is sized at a value lower than the value of the force needed for releasing said blocking means, but such that the traction applied to the door during the release of said blocking means is insufficient for displacing the door.

7. A device intended to be applied to section doors, swinging doors and other similar kinds of doors, in order to allow a correct maneuver of the blocking means when the door is operated by a motor, substantially as described and as shown in the appended drawings.
